(19) United States
(12) Patent Application Publication
(10) Pub. No.: US 2010/0106286 A1
(43) Pub. Date: Apr. 29, 2010

(54) METHOD FOR ORDERING AND ASSEMBLING PRINTED PRODUCTS AND ADD-ON PRODUCTS INSIDE A DISPATCH AREA USING A GUIDE SYSTEM AND A FACILITY FOR REALIZING SAID METHOD

(75) Inventors: Hans Rothenbuehler, Staufen (CH); Thomas Kuenzli, Basel (CH)

Correspondence Address: VENABLE LLP, P.O. BOX 34385, WASHINGTON, DC, 20043-9998, US

(73) Assignee: Mueller Martini Holding AG, Hergiswil (CH)

(21) Appl. No.: 12/604,934

(22) Filed: Oct. 23, 2009

(30) Foreign Application Priority Data
Oct. 24, 2008 (EP) 08405268.7

(51) Int. Cl. G06F 7/00

(52) U.S. Cl. 700/216; 700/219

(57) ABSTRACT

A method for ordering and assembling printed products, processed together with allocated supplements or add-on products, into package bundles, including processing printed products in a dispatch area of a shipping facility, picking and assembling allocated add-on products inside an allocation area, where the allocation area is operatively associated with the dispatch area, and detecting the allocated add-on products using an expanded guide system, wherein the expanded guide system monitors both the dispatch area and the allocation area. The invention further includes facility for selecting and assembling orders. The facility includes a dispatch area to process printed products, an allocation area in which allocated add-on products are picked and assembled, and an expanded guide system adapted to detect the allocated add-on products in the dispatch and allocation areas and to control assembly of printed products together with the allocated add-on products into package bundles.

### CROSS-REFERENCE TO RELATED APPLICATION

This application claims the priority of European Patent Document No. 08405268.7, filed on Oct. 24, 2008, the subject matter of which is incorporated herein by reference.

### BACKGROUND OF THE INVENTION

The invention relates to a method for implementing an order to pick and assemble printed products and add-on products to form finished package bundles. The order is processed inside a dispatch area of a shipping facility with the aid of a guide system. The invention furthermore relates to a facility for realizing this method.

Methods of this type have long been disclosed and permit, for example, the shipping of large series productions of newspapers, magazines and the like. The printed product can be produced directly on the printing press and can also contain inserted products. Manually supplied supplements can also be inserted. The printed products are then supplied to an automatic distribution system and are moved to loading locations for the shipping, for example to a truck, where this can be done either manually or automatically.

The main products can be processed in different ways inside the dispatch area. For example, it is possible to insert supplements in the dispatch area, or the printed products can otherwise be finished and also trimmed. Bundles are furthermore formed and can also be strapped inside the dispatch area, which is generally also provided with a device for affixing addresses to the printed products. A dispatch area guide system is used to control the operational steps. Dispatch area guide systems of this type are disclosed in the art and make possible the route-correct shipping.

For some time now, additional or so-called add-on products have also been processed in these shipping or distribution facilities. If the add-on products are supplied by an external source, they are referred to as external products. External products generally include different types of printed products or advertising items, for example key chains. Internally produced add-on products are referred to as pre-produced products because, as a rule, they are produced ahead of the main product and are made available in an allocation area for the later assembly of the order. The processing and shipping of a main product together with one or more add-on products is also referred to as “co-mailing.” The available add-on products are generally picked and assembled manually. The operator loads the add-on products either before or after the main product onto a ramp, for example into a truck. A ramp in this case is understood to refer to the complete processing region, ranging from the bundle distribution following its production to the loading operation.

### SUMMARY

It is an object of the present invention to provide a method of the aforementioned type, which makes possible an easier and more efficient shipping of the main product together with the pre-produced or externally supplied products. The above and other objects are accomplished according to one aspect of the invention wherein there is provided a method for ordering and assembling printed products, processed together with allocated supplements or add-on products, into package bundles, which, in one embodiment, includes processing printed products in a dispatch area of a shipping facility; picking and assembling allocated add-on products inside an allocation area, wherein the allocation area is located within the dispatch area; and detecting the allocated add-on products using an expanded guide system, wherein the expanded guide system monitors the dispatch area including the allocation area.

The application furthermore relates to a facility for selecting and assembling orders, which, according to one embodiment, includes a dispatch area to process printed products; an allocation area in which allocated add-on products are picked and assembled; and an expanded guide system adapted to detect the allocated add-on products in the dispatch and allocation areas and to control assembly of the printed products together with the allocated add-on products into package bundles.

According to one embodiment, the available add-on products are detected by an expanded guide system. The supplemental or add-on products are thus detected by the dispatch area guide system and, as a result, are integrated into a running production sequence. Since the guide system also covers, or monitors, the allocation area in which the add-on products are picked and assembled, the data for the processing and the mailing of the at least one add-on product can also be supplied to or can be imported into the guide system.

According to a further embodiment, the imported or importable production data may advantageously include the data for processing the main product as well as the data for processing the at least one add-on product. Production data of this type can be used to generate delivery documents, invoices or electronic displays, containing instructions for manual or automatic picking and assembling at the work station.

According to another embodiment, a picking and assembling instruction of this type can also include a plurality of different titles or external products, which must be gathered into an assembly unit, for example a packing unit. On the basis of such a delivery invoice or a corresponding electronic display of this type, the add-on products can be removed manually or automatically from a storage area and can be supplied to a packing unit. As a result, the guide system can be used for picking and assembling an order consisting of pre-produced or externally supplied products, as well as for the delivery. The main production can thus be coordinated with the picking and assembling as well as the delivery of the add-on products.

According to an embodiment, updated data may be used for generating the delivery invoices or the displayed information, which makes it easy to take into account changes to editions, delivery numbers, or delivery locations that must be made on short notice. The picking and assembling and the loading of the add-on products is synchronized with the production of the main product.

According to a further embodiment, the guide system can also be used to monitor the delivery of the assembled units, meaning in particular the packing units. For example, the delivery of the packing units to the docking area and the dispatch area can be visualized using electronic displays.

Another embodiment may include the option of coordinating the assembled units, especially the packing units, with the individual loading locations or docking areas for the trucks. It is furthermore possible to display the production data so that truck drivers can view the status of the production segment assigned to them. One advantage of the invention is the possible savings in time and the flexibility when rescheduling shipping orders, thereby resulting in considerable cost savings.

### BRIEF DESCRIPTION OF THE DRAWINGS

The present invention will be more readily understood from the following detailed description when read in conjunction with the accompanying drawings, in which:

FIG. 1 is a schematic showing a shipping facility as disclosed in the prior art;

FIG. 2 is a schematic showing a shipping facility according to an embodiment the present invention; and

FIG. 3 is a block diagram of the operational sequence of the shipping facility according to an embodiment of the present invention.

### DETAILED DESCRIPTION

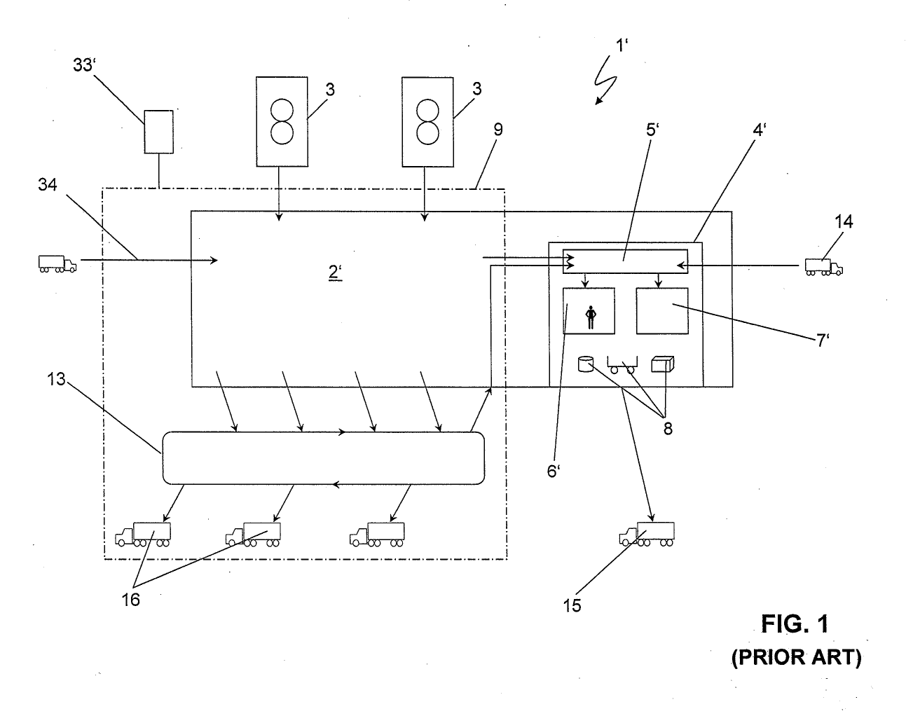

FIG. 1 illustrates a shipping facility 1′ of the type as disclosed in the prior art. This system comprises a dispatch area 2′ in which printed products, not shown herein, are processed online by printing presses 3 to form print matter, which is also referred to as the main product.

Print matter or a main product in this case can consist of individual printed products that are printed online with the aid of one or a plurality of printing presses 3, as well as pre-printed products or products supplied by an external source to the dispatch area 2′ via a delivery 34. The print matter, for example, could be daily newspapers, which are printed with an offset or digital printing technique on at least one of the printing presses 3. However, it is also conceivable that one of the printing presses 3 may be used for printing a supplement or a pre-produced product. This pre-produced product can be stored in an intermediate storage area 5′.

In the dispatch area 2′, the printed products are processed, for example cut or trimmed, and are provided with a supplement or add-on, etc. The printed products are furthermore bundled and these bundles can subsequently be provided with an address or a cover sheet. Finally, the printed products may be turned over to an automatic bundle distribution system 13. For conveying the bundles, this system can be provided with an endless conveyor, not mentioned in further detail herein, onto which the bundles can be deposited automatically so that they can be transferred to a transport device 16 such as a truck for the shipping. This transport device 16 then transports the package bundles to intended destination locations or to recipients of the print matter.

Furthermore, add-on products, not shown herein, may be loaded onto the transport device 16 and are picked and assembled inside an allocation area 4′. The allocation area 4′ is usefully arranged in or directly adjacent to the dispatch area 2′. However, it is also conceivable that the allocation area 4′ is not arranged in the same building as the dispatch area 2′, but is geographically separate from the dispatch area.

The allocation area 4′ includes the intermediate storage area 5′ in which the pre-produced and externally produced add-on products are stored temporarily. Products supplied by an external source can include any type of products, meaning they are not necessarily printed products, but can also be, for example, letter mail, foodstuffs, toys, sound carriers or advertisement items such as key chains, product samples, etc. These products are generally supplied by an external source with the aid of a transport device 14, for example a truck, and are deposited in the storage area 5′.

The storage area 5′ can also contain pre-produced products which are printed with one of the printing presses 3 either before or during the main production. The external products are either picked and assembled manually in a manual allocation area 6′ or automatically in an allocation area 7′ and are inserted into packing units 8. The control of the automatic allocation area 7′ is therefore autonomous, which means that the information for picking and assembling the order can only be input at the automatic allocation area 7′ and can be used only for controlling the picking and assembly operation in this area.

The packing units 8 form picking and assembling units, wherein the reference number 6′ indicates a manually selected and assembled unit. The packing units 8 that contain externally supplied products or, if applicable, pre-produced products are loaded manually into a transport device 15. This transport device can be loaded ahead of time, at the same time, or afterwards with the print matter or the main products. The transport device 15 can therefore also be equivalent to transport device 16.

The processes in the dispatch area 2′ are monitored and controlled by a guide system 33′, which covers a detection region 9. The guide system 33′ in the process links all partial processes inside the dispatch area 2′, which ensures that all operational steps are linked to each other as required for the practical operations. The guide system permits a central and up-to-date overview over all processes and an optimum material flow in the detection region 9. The guide system 33′ furthermore supports the planning and controls the production.

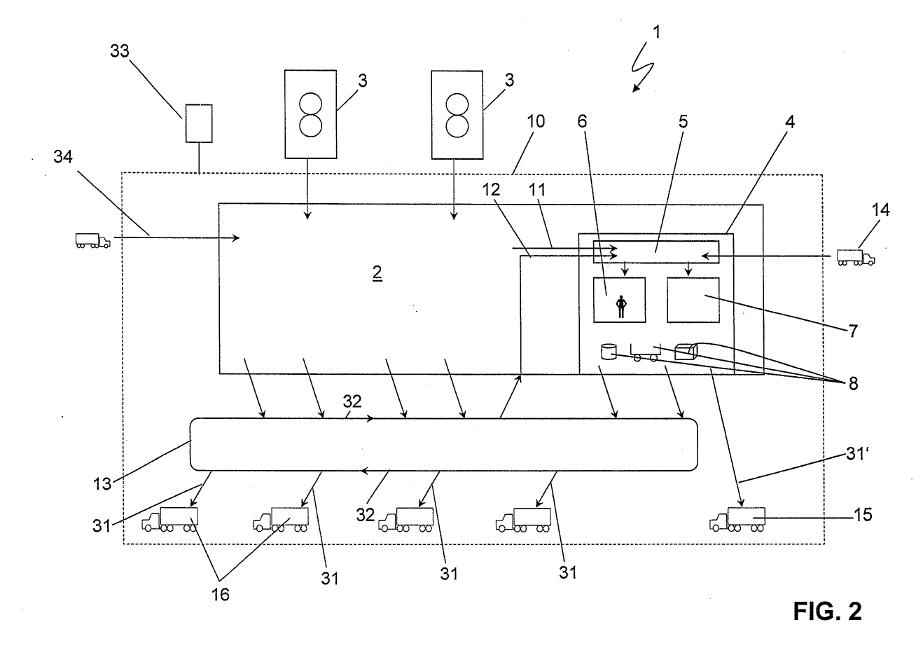

The shipping facility 1 according to the embodiment, shown in FIG. 2, similarly has a dispatch area 2 in which the print matter or the main product is processed during a main production operation, as explained above. The print matter is then transferred to a bundle distribution 13 and is finally loaded onto the transport device 16, where the loading takes place at the respective loading locations 31. The bundles transported by the bundle distribution system 13 are, for example, transported in the direction of arrows 32 in a clockwise direction. However, a transport in a counter-clockwise direction is also conceivable. The bundle distribution may be automatic. It is furthermore conceivable that smaller shipping facilities 1 are not provided with a bundle distribution system 13 and that the bundles are distributed manually, based on instructions by the guide system, for example with the aid of one or more loading ramps.

The processes inside the dispatch area 2 are monitored and controlled by an expanded guide system 33, which covers a larger detection region 10. In addition to the area monitored by the above-described guide system 33′, the expanded guide system 33 also monitors and controls the allocation area 4 in the detection region 10.

The dispatch area 2 also includes an allocation area 4. Products that are pre-produced in the dispatch area 2 can be supplied directly via a delivery 11 or indirectly via the bundle distribution system 13 and a delivery 12 to the storage area 5 of the allocation area 4. These pre-produced products are printed products, for example, which are printed by one of the printing presses 3 and are stacked on pallets, wound onto rolls, compressed into bundles, packaged into containers or supplied individually or in an overlapping flow with the aid of a conveyor to the allocation area 4. However, the pre-produced products can also be produced outside of the shipping facility 1 and can be supplied to the storage area 5.

The storage area 5 furthermore includes products from an external source, as mentioned above, which are supplied either before or during a main production run with the aid of transport device 14. The products from the external source and, if applicable, the pre-produced products are picked and assembled manually or automatically, as mentioned above, and are deposited in the packing units 8. The packing units 8 can take the form of roll carts, baskets, pallets, boxes or other suitable containers. The delivery to the storage area 5 need not necessarily be automatic and may be controlled by the aforementioned guide system. This expanded guide system 33 contains the production data for the main product, the pre-produced product as well as the add-on products. The expanded guide system 33 thus covers, or monitors, the main production, meaning the processing of printed products into print matter, as well as the allocation area 4 for the add-on products.

The expanded guide system 33 respectively generates up-to-date delivery information for the picking and assembling operation in the allocation region 4, for example a paper delivery invoice or a corresponding digital display. Based on this delivery information, the delivery invoices or the respective displays, e.g. on a monitor, the packing units 8 are loaded manually or automatically with the add-on products and can be transferred manually or automatically via the bundle distribution system 13 at a shipping location 31′ to a transport device 15. The transport device 15 can again also be equivalent to transport device 16.

The delivery information in the form of delivery invoices or documents or digital displays provide automatic loading instructions and are synchronized via the guide system 33 with the main production. As a result, it is ensured that the correct number and the correct type of external products are available at the desired point in time inside a suitable packing unit 8 at the desired loading location 31, 31′. The delivery can therefore be monitored as well as visualized. As a result, it is possible to display the current loading status of the main products as well as the add-on products, for example at the loading locations 31. The guide system thus provides the operator at the manual allocation location 6 in the allocation area 4 with the information for the correct loading of the packing or assembly units 8 and for the insertion of the assembly units 8 at the correct point in time into the bundle distribution 13 or to supply them to the loading location 31′.

With the aid of the information provided by the guide system 33, the operator knows precisely when and how many bundles are provided, how large the bundles are supposed to be, and which pre-produced products or external products the assembly unit or the packing unit 8 must contain. With the guide system 33, it is also possible to display the progress made in the production on the whole or for each main product, pre-produced product or externally supplied product which is respectively transported with the transport device 15 or 16. The operator is also precisely informed of which packing unit must be supplied at what point in time to which transport device 15 or 16.

So that the expanded guide system 33 can correspondingly control the dispatch area 2 and the allocation area 4, the production data for the main production and the external production and, if applicable, for the pre-produced products are also supplied to the guide system 33 and are recorded therein. Route information with delivery locations for the transport device 15, 16 can be further imported, if necessary. Based on this information, so-called collective jobs are formed for each transport device 15 or 16 by the guide system, which also stores the aforementioned picking and assembling instructions for the manual allocation 6 in the allocation area 4. The guide system 33 can furthermore generate cover sheets, which can contain the picking and assembling instructions for the manual allocation 6, as well as information designed for the operators of the transport device 15, 16.

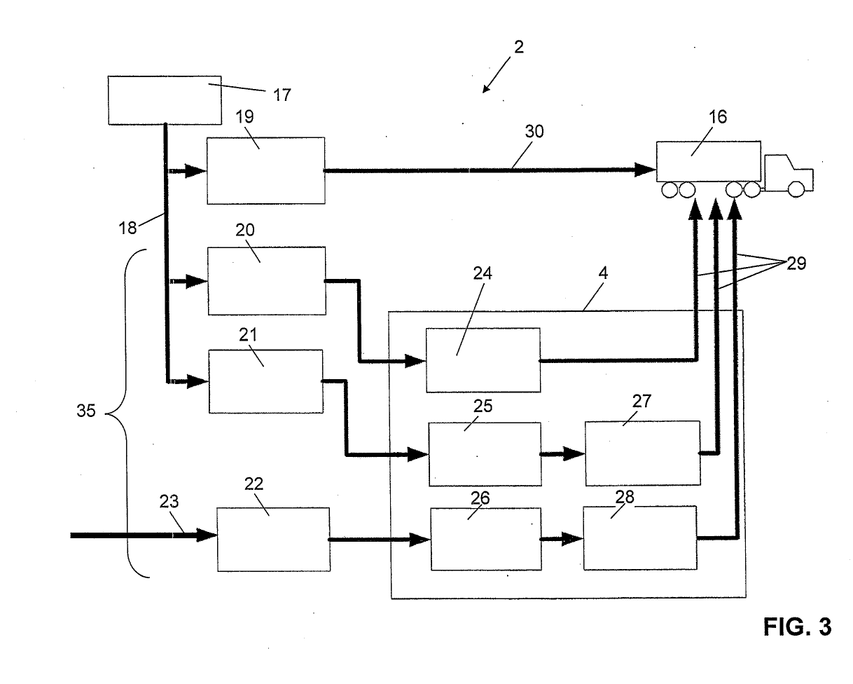

FIG. 3 provides an overview of the operational sequence. A production 17 includes a main production 19, a production 20 for pre-produced products, and a production 21 for additional pre-produced items. The production 17 can take place within or outside of the dispatch area 2, for example with the aid of at least one of the above-mentioned printing presses 3. The production 20 for pre-produced products, the production for additional pre-produced products, and the production 17 can be combined to form add-on products 35. The arrow 18 indicates the corresponding division. The main production 19 relates, for example, to a daily newspaper while the production 20 relates to an automatic processing of a pre-produced product such as a different daily newspaper. The pre-produced production run 21 involves a manual processing of a pre-produced product. As mentioned above, the production 17 is controlled by the guide system that is provided with the respective data. Externally produced products 22 are delivered to the dispatch area 2 as shown by arrow 23. These external products 22 are generally produced outside of the dispatch area 2.

The main production run 19 or the corresponding print matters or main products are loaded directly from the dispatch area into the transport device 16, as shown by arrow 30. The main products can be stitched and trimmed or otherwise finished and processed together with the supplements. As a rule, corresponding bundles are formed and these bundles are addressed or provided with cover sheets. The bundles may be loaded automatically via the aforementioned bundle distribution system 13.

The add-on products 35 are supplied to the allocation region 4, which includes a storage area 24 for each transport device 15, 16 for the pre-produced products 20, a storage area 25 for the pre-produced products 21 and a storage area 26 for the externally produced products 22. The pre-produced products from the storage area 24 can be supplied separately and automatically via a suitable transport system to the transport device 16. The pre-produced products from the storage area 25 and the externally produced products from the storage area 26 are picked and assembled manually or automatically, for example as indicated with the reference numbers 27 and 28. The delivery to the transport device 16 can be in three ways as shown by arrows 29.

The method can furthermore relate to a production run that involves only the main production 19 and the picking and assembling from the storage area 26. The transport device 16, in this embodiment, is supplied only with main products and products from an external source. Also conceivable is the delivery of a plurality of different externally-produced products or pre-produced products, where only the integration of the allocation region 4 into the main production is required. The picking and assembling instructions in the allocation region 4 are thus issued by the guide system which controls the main production 19.

It will be understood that the above description of the present invention is susceptible to various modifications, changes and adaptations, and the same are intended to be comprehended within the meaning and range of equivalents of the appended claims.

What is claimed is:

1. A method for ordering and assembling printed products, processed together with allocated supplements or add-on products, into package bundles, comprising:
processing printed products in a dispatch area of a shipping facility;
picking and assembling allocated add-on products inside an allocation area, wherein the allocation area is operatively associated with the dispatch area; and
detecting the allocated add-on products using an expanded guide system, wherein the expanded guide system monitors both the dispatch area and the allocation area.

2. The method according to claim 1, further comprising supplying the expanded guide system with data to process the allocated add-on products.

3. The method according to claim 1, further comprising:
automatically or manually supplying at least one allocated add-on product to at least one assembly unit; and
making available to ship the at least one allocated add-on product in the at least one assembly unit.

4. The method according to claim 3, further comprising loading manually or supplying the assembly unit to an automatic bundle distribution system.

5. The method according to claim 1, further comprising generating at least one picking and assembling instruction for the allocated add-on products based on imported data by the expanded guide system.

6. The method according to claim 5, further comprising generating at least one delivery invoice or an electronic display, wherein the at least one delivery invoice or electronic display displays or contains the at least one picking and assembling instruction.

7. The method according to claim 5, further comprising generating the at least one picking and assembling instruction for a manual allocation.

8. The method according to claim 5, wherein the at least one picking and assembling instruction contains correct instructions for a depositing location, a route, or a vehicle.

9. The method according to claim 5, wherein the at least one picking and assembling instruction relates to several different allocated add-on products.

10. A facility for selecting and assembling orders, comprising:
a dispatch area to process printed products;
an allocation area in which allocated add-on products are picked and assembled, wherein the allocation area is operatively associated with the dispatch area; and
an expanded guide system adapted to detect the allocated add-on products in the dispatch and allocation areas and to control assembly of the printed products together with the allocated add-on products into package bundles.

11. The facility according to claim 10, wherein the dispatch area and the allocation area together comprise a detection region to be detected by the expanded guide system.
